(19) United States
(12) Patent Application Publication
(10) Pub. No.: US 2018/0109403 A1
(43) Pub. Date: Apr. 19, 2018

(54) Energy efficient highway addressable remote transducer C8PSK modem

(71) Applicant: Pranatharthi Subbaratnam Haran, Fremont, CA (US)

(72) Inventor: Pranatharthi Subbaratnam Haran, Fremont, CA (US)

(73) Assignee: Smart Embedded Systems, Inc., Fremont, CA (US)

(21) Appl. No.: 15/294,680

(22) Filed: Oct. 15, 2016

(51) Int. Cl. H04L 27/10; H04L 27/18; H04L 27/22; H04L 1/20; H04L 27/01

(52) U.S. Cl. CPC H04L 27/10; H04L 27/18; H04L 27/01; H04L 1/206; H04L 27/22

(57) ABSTRACT

A method and a Highway Addressable Remote Transducer (HART) soft modem device (SMD) for transmitting a C8PSK signal and receiving and demodulating an Analog signal in either FSK or C8PSK comprising a HART message is provided. A transmitter of HART-SMD improves efficiency by reducing the computation complexity with a novel table lookup technique. A demodulator of the HART-SMD receives the Analog signal, samples and converts the Analog signal into digital data at a predetermined digital sample rate. The demodulator implements a two-step phase estimation technique followed by a single step timing estimate to achieve an optimal operating region for the receiver so that the receiver can be ready to receive state in a very short time as required in C8PSK specifications. A simple method of doing automatic modulation classification by negating the presence of an FSK modulation by the positive assertion of the presence of C8PSK modulation, or by the absence of C8PSK Signal and the presence of Energy detect to assert the presence of FSK signal is also stated.

### FIELD OF THE INVENTION

The present invention relates to the Highway Addressable Remote Transducer (HART) system. More specifically the present invention relates to HART C8PSK modem which is used in field work.

### BACKGROUND OF THE INVENTION

The smart field data devices which are in use today are generally Highway Addressable Remote Transducer (HART) enabled devices. HART is a global standard for sending and receiving digital information across Analog wires between smart devices and control or monitoring systems. The HART communications protocol is widely recognized as the industry standard for digitally enhanced 4 milli-ampere (mA) to 20 milli-ampere (mA) smart instrument communication. Use of the HART based technology is growing rapidly and today most of the major global instrumentation suppliers offer products with the HART communications protocol. The HART communications protocol enables two-way digital communication with smart instruments without disturbing 4 mA-20 mA Analog signals. The HART communications protocol utilizes, for example, the Bell 202 frequency shift keying (FSK) standard of the Bell 202 modulator-demodulator (modem) of Bell System to superimpose digital communication signals at a low level over the 4 mA-20 mA Analog signals. This process enables the two-way field communication and makes it possible for the additional information beyond the typical process variables to be communicated, to and from a smart field instrument.

The current deployment of Highway Addressable Remote Transducer (HART) field data devices utilizes a hardware based Bell 202 modem at 1200 bits per second and a separate microcontroller for a HART communications protocol implementation. There are a number hardware based modems available in the industry using the Bell 202 based modulation scheme.

The HART Communication Foundation has published a higher speed communication protocol at 9600 bits per second speed using a C8PSK (Phase Shift Keying) modulation and demodulation scheme in 2001. Due to technical difficulties, the implementation of this in a low power HART environment and to be compliant to HART specifications has been a significant challenge.

Academic papers have been written on how the implementation can be done more efficiently by minimizing the number of multiplications needed by the algorithms. The academic papers include “High Speed HART Prototype Modem Project,” Prepared for The HART Communication Foundation. USA, 1999:35-60. By Fisher Rosemount; The HART PSK Physical Layer, A Status Report to HCF Members [R]. USA, 2000:6-7. By Wally Pratt and “Low-Power Digital Receiver Structure for Multi-Speed HART”, International Journal of Digital Content Technology and its Applications. Volume 5, Number 4, April 2011. By Zhenghua Jin, Hong Wang, Zhijia Yang. Even these ideas are not quite suitable for low power and low cost implementations. A typical HART modem comprises of mainly two parts namely the modulator and the demodulator. In order to achieve power and, efficiency, both of these functions need to be optimized for power and performance. Although the modulator is inherently less complex, efficiencies can be achieved here as well. The modems which are typically done in Application Specific Integrated circuits (ASICS), are harder to implement C8PSK modem, because the existing C8PSK modem algorithms are too complex to implement in ASICS due to their multi-stage decision making process. Hence, there is a long felt but unresolved need for workable low power techniques for a C8PSK modem implementation. By implementing efficient algorithms of lower complexity and lower computational demands, this invention makes new ground in the C8PSK solution for HART communications.

One of the additional requirements needed in the HART C8PSK, implementation is the simultaneous detection of the slower 1200 bits per second Bell 202 based FSK modulation signals. This is normally implemented by one of many Automatic Modulation Classification (AMC) methods. Many of these are computationally intensive and needs to be done at a high signal sample rate.

### OBJECTS OF THE INVENTION

The object of the present invention is to provide a novel technique which helps to achieve higher level of efficiencies in both the modulator and the demodulator of the HART modem.

Another object of the present invention is to provide a novel method for modulating and transmitting an Analog signal comprising a HART message.

Another object of the present invention is to provide a two-step estimation method for Phase error estimation of the incoming C8PSK signal.

Another object of the present invention is to provide a decision estimator which is used in timing estimation with phase error estimation and equalizer selection.

### SUMMARY OF THE INVENTION

The present invention mainly describes a HART C8PSK modem. This invention uses novel techniques which achieve higher level of efficiencies in both the modulator and the demodulator. The HART modem device is used to transmit the C8PSK Analog signal comprising of a HART message which is received and demodulated to a digital signal in either FSK or C8PSK.

The present invention provides an efficient method for modulation of the Highway Addressable Remote Transducer (HART) which involves three steps, namely pre-calculation of all the waveforms, generating the look-up table and creating the actual lookup of the table to recreate the waveforms. The initial step of the method used in the present invention involves pre-calculating all these different waveforms and the resulting waveforms are stored in the non-volatile memory of the microprocessor.

The invention further makes use of the novel idea of limiting other waveforms, using the special nature of the requirements where the carrier frequency is specified as 3200 Hz and the baud rate is specified as 3200 per second. As the phase of the sine wave is exactly the same after each baud and the sine wave repeats itself, a lookup table can be designed based on this and also the lookup table size can be minimized.

In the process of pre-calculating the waveforms, there can be interference posed by infinite such waveforms which may require larger memory for a typical implementation. The present invention further uses a method of limiting such waveforms, using the special nature of the requirements where the carrier frequency is specified as 3200 Hz and the baud rate is specified as 3200 per second.

The second step which is used in the modulation of the HART modem includes the designing of a look-up table. The main criteria used in the designing of a look-up table and minimizing the look-up table size is the fact that the phase of the sine wave is exactly the same after each baud and the sine wave repeats itself The final step is the waveform generation using a table lookup method with the help of the table generated in the first two steps.

The modulated C8PSK output is received by a C8PSK receiver. The Analog to digital converter present in the receiver converts the incoming signal into digitized samples. The main challenge which is faced by the C8PSK receiver is to get the receiver in the optimum detection range within a period of 40 bands or symbols. In order to achieve this range, a fast detection of incoming phase of the signal and the centre point timing of the (I/Q) waveform must be estimated.

The demodulator used in the present invention uses a two stage phase estimation method followed by timing estimation and the optimum equalizer selection. The Phase Estimation process starts after sufficient energy has been detected by the Energy Detect circuit. After this, it collects the first 8 symbols of I and Q samples from the output of Low Pass Filter. The SumI and SumQ are calculated and the four Quadrant decision making is done based on the sign of SumI and SumQ. By comparing the magnitudes of Sum I and Sum Q, the phase error estimate is narrowed down to within plus or minus 22.5 degrees. The Phase Error estimation happens in two steps. In the first step, a coarse estimation is made within a 45 degree range and in the second step, it is further refined with a precise final estimate.

The timing estimation starts with calculating two rate of change values called Slope1 and Slope2. Slope 1 and Slope 2 are rotated by 22.5 degrees using a simple Cartesian rotation method in order to calculate the decision estimator. The decision boxes decide that the value belongs to which of the four Quadrants. Decision boxes in further stages resolves it to the exact choice of Equalizer timing and the timing offset. Once this choice is made, the equalizer is allowed to adapt to full convergence and the demodulation results in proper decoding of data.

The present invention describes the selection of the equalizer coefficients. A single pre-determined equalizer is chosen and the timing estimator is calculated based on Gardner's algorithm which is used to estimate the delay and it is fed back to the interpolator, which can work twice per symbol. The Slope 1 and Slope 2 estimates are calculated and fed to the decision estimator which results in the choice of 1-8 timing estimates. This gives the accurate estimate with lower computational requirements and it results in reliable demodulation of the C8PSK signals.

In the present invention, the system detects certain patterns in the C8PSK demodulated I and Q signals which is a clear and reliable indication of the presence of the C8PSK signal and by inference an absence of the Bell 202 FSK signal. Once the absence of C8PSK signal is asserted, the system switches to the FSK demodulation method and detects the incoming FSK signals in time.

### BRIEF DESCRIPTION OF THE DRAWINGS

FIG. 1 describes the symbolic representation of 8 different sine waves of the C8PSK modulation scheme.

FIG. 2 describes how a typical C8PSK modulator is implemented to generate the modulated signals.

FIG. 3 describes how a typical C8PSK demodulator is implemented to receive demodulated digital data.

FIG. 4 represents a more efficient receiver structure.

FIG. 5 represents the process of calculation of address of the location of a sample waveform.

FIG. 6 describes a C program of the table lookup method described in the present invention.

FIG. 7 illustrates the calculation of the filter output of the raised cosine filter while calculating the table lookup entries.

FIG. 8 represents the flow diagram of the C8PSK receiver structure which is used for generating I and Q signals.

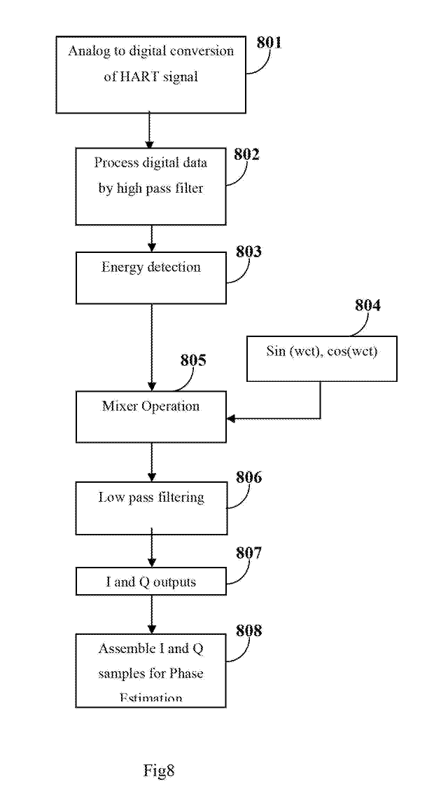

FIG. 9 represents a flow diagram of the major sequence of steps involved in the algorithm to arrive at the optimal phase error correction and equalizer starting point.

FIG. 10 represents a flow diagram of arriving at phase error estimation to one specific Quadrant.

FIG. 11 represents the continuation of the phase error estimation to be within 45 degrees.

FIG. 12 shows the estimation of final phase correction.

FIG. 13 represents the flow diagram of algorithm selection to correct equalizer with the optimum timing based on I and Q values.

FIG. 14 describes all the equations used in the present invention.

### DETAILED DESCRIPTION OF THE INVENTION

The present invention provides an efficient method for modulation of the Highway Addressable Remote Transducer (HART) involving three steps, namely pre-calculation of all the waveforms, generating the look-up table and creating the actual lookup of the table to recreate the waveforms. The pre-calculations of all the waveform in followed by the generation of the look-up table would be offline at a desktop or with the help of other computing methods. The final step of the creation of actual lookup of the table to recreate the wave forms is implemented with the help of an actual HART transmitter where a least complex implementation is required.

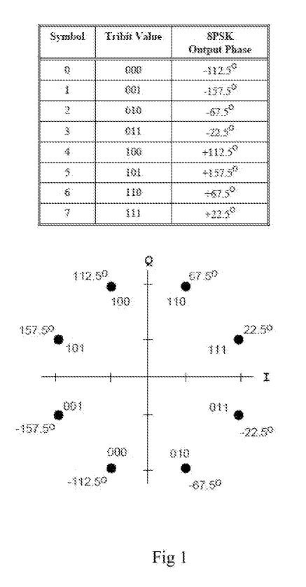

FIG. 1 describes the symbolic representation of 8 different sine waves of the C8PSK modulation scheme with 8 different phases which is represented by dots with X axis depicting real (I) and y axis depicting imaginary (Q) parts. Higher speed HART transmitter devices use HART C8PSK (Phase Shift Keying) modulation to transmit the HART communication signals. An 8 point PSK modulation involves converting the digital data into 8 different sine waves having a different phases. Mathematically this is broken down into a sine component and cosine component represented in FIG. 1 as X and Y coordinates.

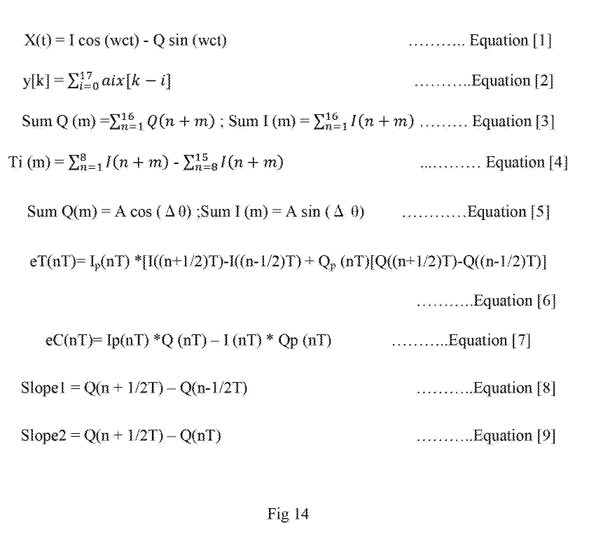

They are commonly referred to as In Phase (I) and Quadrature (Q) components. This can be mathematically depicted as per FIG. 14 Equation [1] as;

X(t)=I cos(wct)−Q sin(wct)

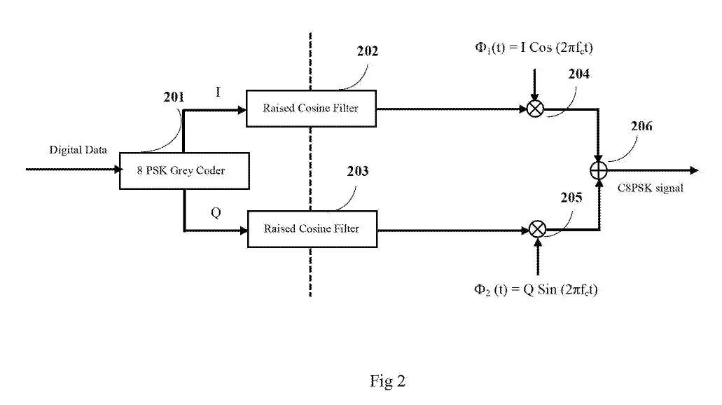

As described in FIG. 2, X(t) can be calculated by taking a sequence I signals and shaping through a raised cosine filter and taking a sequence Q signals through another raised cosine filter and the final output is required to be modulated using a carrier frequency of 3200 Hz. By multiplying the resulting raised cosine filter output I with cos (wct) and subtracting from it the product of the raised cosine filter output of Q multiplied by sin (wct).

The novel method proposed in the present invention involves pre-calculating all these different waveforms and storing the resulting waveforms in the non-volatile memory of the microprocessor. There could be infinite such waveforms and they may require much too larger memory for a typical implementation. The present invention further uses a method of limiting such waveforms, using a special nature of the requirements where the carrier frequency is specified as 3200 Hz and the baud rate is specified as 3200 per second.

The fact that the phase of the sine wave is exactly the same after each baud and the sine wave repeats itself is the main criteria in designing the look-up table and also in minimizing the look-up table size to several kilo bytes. For example: The I and Q filters are selected to span 3 bauds with 3 bits per baud and with a choice of 8 digitized samples per baud, a lookup table is designed having 8 times, 8 times, 8 bytes (8×8×8). This results in a manageable lookup table size of only 4096 bytes.

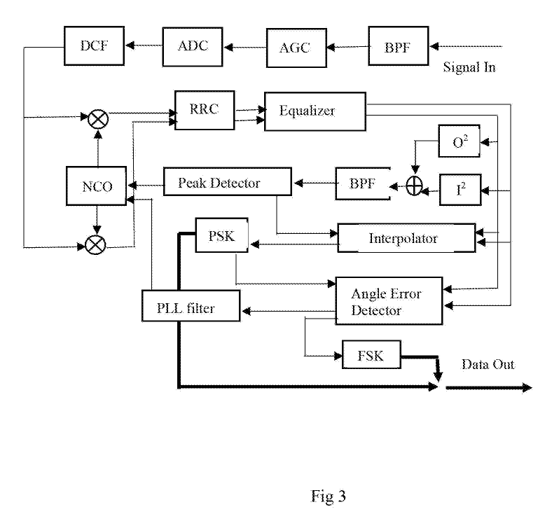

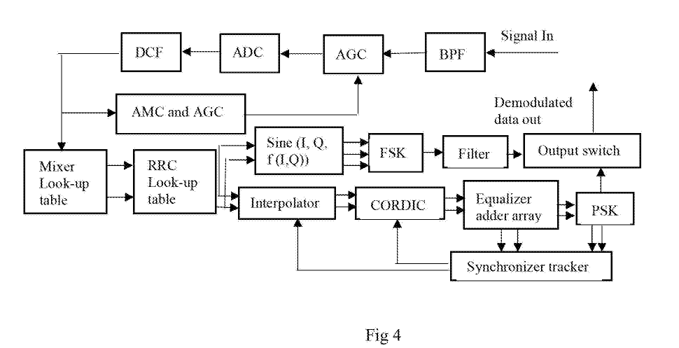

FIG. 3 represents the receiver structure of a typical HART modem as described in the prior art “Low-Power Digital Receiver Structure for Multi-Speed HART” whereas the FIG. 4 represents a newer modified receiver structure of the present invention. The FIG. 4 describes the modified receiver structure comprising of a fixed single pre-set equalizer which easily adapts to the actual line conditions that are present at that point of time. It has been tested in the typical HART modem in order to find out that in the real life conditions, the equalizer convergence and proper demodulation of the signal was not always successful.

In a typical HART modem, the phase of the incoming C8PSK signal can be estimated with the help of the equations [3], [4] and [5] from FIG. 14. The phase of incoming C8PSK signal can be estimated by using Δθ.

Δθ=45*k+m.

As described in the prior art “Low-Power Digital Receiver Structure for Multi-Speed. HART”. the resulting SumQ(m) and SumI(m) goes through the PSK decision module which issued to calculate the function parameter k a little lookup table of abstract value SumQ(m) is used to compute m. The values of k and m are used to calculate Δθ as mentioned above. The specific implementation reveals that it requires sampling the signal at 8 times the baud rate of 3200 resulting in a very high sampling rate of more than 25 KHz.

The present invention proposes the use of the sampling rate of only 4 times the baud rate at 12800 Hz and using a two stage phase estimator wherein in the first stage, an approximate estimate of the phase within 45 degrees is made by using the decision module and in the second stage a single accurate estimation is done by doing ARC TAN estimation of the quotient of SumI (m) and SumQ (m). Since tan(θ)=θ for small angles, the quotient itself can be approximated as an estimate of arc tan. The illustrated two-step method is having significantly less computations.

As described in the prior art “Low-Power Digital Receiver Structure for Multi-Speed HART”, the second part of the invention describes the selection of the equalizer coefficients. In the prior art, an algorithm is used where a single pre-determined equalizer is chosen and the timing estimator is calculated based on Gardner's algorithm in equation [6] from FIG. 14 which is given below, i.e.

eT(nT)=Iₚ*[I((n+½)T)−I((n−½)T)+Qₚ(nT)[Q((n+½)T)−Q((n−½)T)]

In the prior art, this equation is used to estimate the delay and the delay estimate is fed back to the interpolator which can work twice per symbol. The carrier phase of a typical HART modem is calculated with the help of the equation [7] as described in FIG. 14 i.e.

eC(nT)=Ip(nT)*Q(nT)=I(nT)*Qp(nT)

The algorithm and the interpolator described, in the prior art “Low-Power Digital Receiver Structure for Multi-Speed HART” are in general computationally more intensive. The method in the present invention involves calculating the Slope 1 and Slope 2 as described in equation [8] and equations [9] of FIG. 14.

Slope1=Q(n+½T)−Q(n−½T)

Slope2=Q(n+½T)−Q(nT)

Where
Q=Quadrature component of the demodulated signal and
T=the baud or the symbol period.

In the present invention, the Slope 1 and Slope 2 estimates are calculated using above mentioned equations and fed to the decision estimator which results in the choice of 1-8 timing estimates. For Example: If we select from 1 of 4 different equalizers and with or without a timing offset of ½T, this method results in accurate estimate with lower computational requirements and also results in reliable demodulation of the C8PSK signals.

In the present invention, certain patterns are detected in the C8PSK demodulated I and Q signals which is a clear and reliable indication of the presence of the C8PSK signal and by inference an absence of the Bell 202 FSK signal. Once the absence of the C8PSK signal is asserted, one can easily switch to the FSK demodulation method and still reliably detect in time the incoming FSK signals.

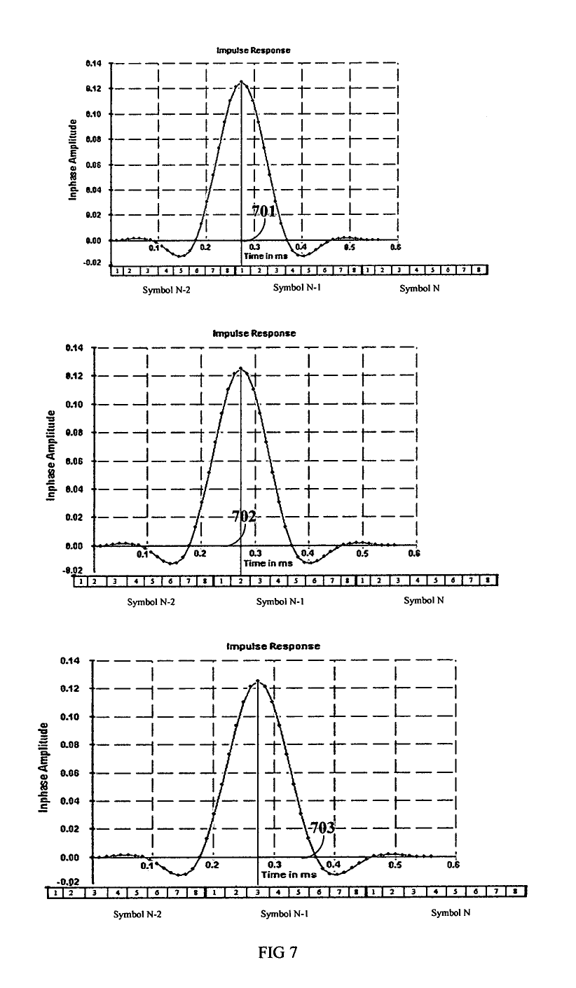

Another embodiment of the present invention describes the generation of the table to create 512 different possible C8PSK modulated waveforms with each for having 8 samples representing 1 baud period of the signal. The count of 512 possible waveforms is arrived at as follows: The raised cosine filter is assumed to be 2 bauds plus one sample long, making it 3 bauds long. This also makes the raised cosine filter 17 taps long at a sample rate of 25600 Hz, 8 times the C8PSK baud rate of 3200 Hz. Digitized data is processed through Grey encoder 201 and results in 8 different combinations of I and Q values as described in FIG. 1 showing the 8 different I and Q locations. There are 8 samples per baud and as we go from one sample to the next, I/Q wave forms shifts to the next position. It goes from position 1 ((701) to 2 (702), then 2 to 3 (703) and after position 8, it completely moves to the next baud slot in symbol N−1 from symbol N−2 which is seen depicted in FIG. 7. The digital filter output is simply a product and summation of the symbols. The filter coefficients are calculated as shown in 202, 203.

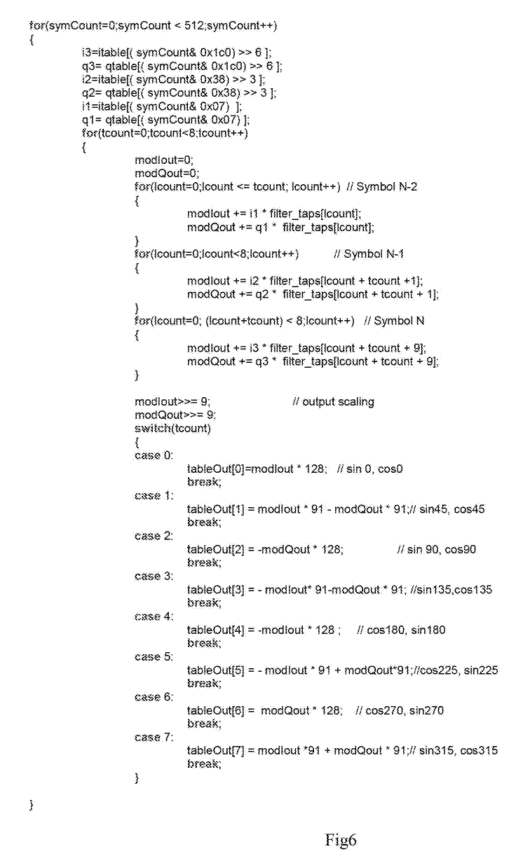

FIG. 2 describes the final step which is to modulate I and Q filter outputs with sine 204 and cosine wave 203 function to generate the output waveform values 205. The output would have 8×8×8×8 table values, Each for the first three 8s represented by 3 bits each as in 501, 502, 503 represent the eight possible symbols for each position in the three baud samples and the last 8 by 3 bits as in 504 represents the eight samples per baud. The program which is described in the FIG. 6 shows how this is calculated.

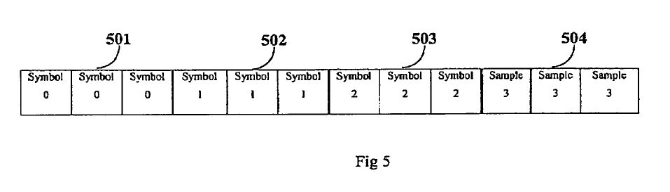

The final step is the waveform generation using a table lookup method using the table generated in the first two steps. The first step in this process is to assemble the lookup table entry location. This is consists of the three sequential symbols being, transmitted. Each symbol is represented by 3 bits 501, 502, 503 for identifying the 8 possible C8PSK symbols. 504 selects each of the eight samples to be the output in one baud, The resulting entry is shown in FIG. 5.

Using this entry and the look up table which is generated from earlier steps, the C8PSK modulated output can be generated with only a few instructions. In a specific embodiment of this method in Texas Instrument's MSP430 microcontroller, it will take less than 1 MHz of CPU cycles. This results is significant power and cost savings over any other method.

The front-end of the C8PSK. receiver is same as in many PSK receivers. The Analog to Digital Converter 801 converts the incoming signal into digitized samples. In one embodiment, this sample rate is at 12800 Hz. High pass Filter 802 removes any low frequency interferences and feeds it to the Energy Detector 803. Once the Energy detector sees sufficient signal level, it proceeds with further operation. Otherwise, the CPU stays in Low Power mode as described in Equation 5 of FIG. 14. The mixer uses sine 805 and cosine 804 values of appropriate phases to generate a low frequency components containing I and Q signals and unwanted high frequency components. Since the low frequency component contains I and Q signals, Low Pass Filter 806 generates the desired I and Q outputs 807. These I and Q signals are further used for Phase estimation, timing estimation and demodulation. All the above steps are the standard part of any standard PSK receiver.

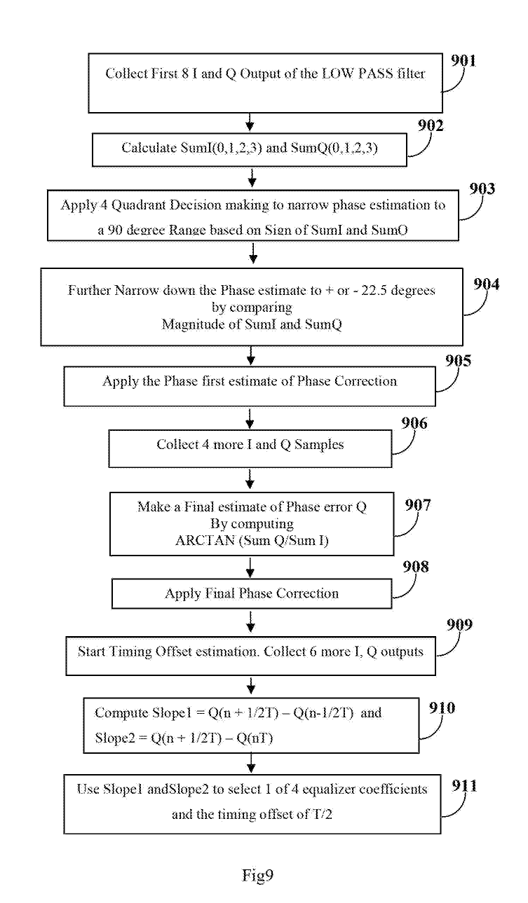

The main challenge which is faced by the C8PSK receiver is to get the receiver in the optimum detection range within a period of 40 bauds or symbols. In order to achieve this range, a fast detection of the incoming phase of the signal and the centre point timing of the (I/Q) waveform must be estimated. The method described in the reference patent “Low Complexity Synchronization Algorithms for HART C8PSK”, and in equations [4] and [5], needs a very high sample rate of 25600 Hz. This would still require a lot of computing cycles which may exceed the current limitation of the HART circuit. In the present invention, FIG. 9 describes a two stage phase estimation method followed by timing estimation and the optimum equalizer selection.

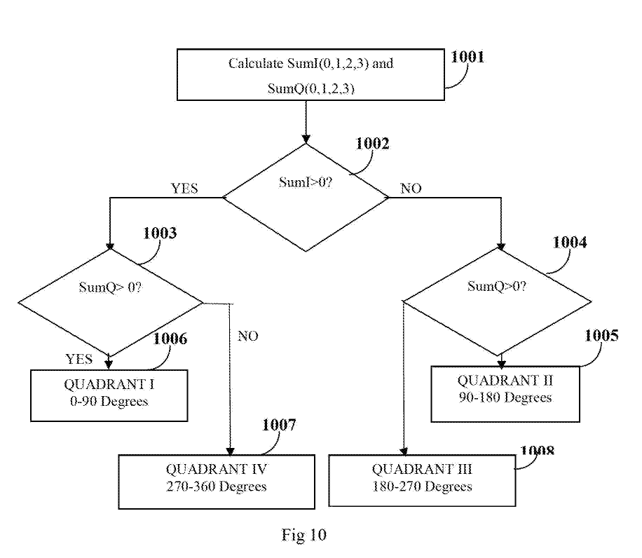

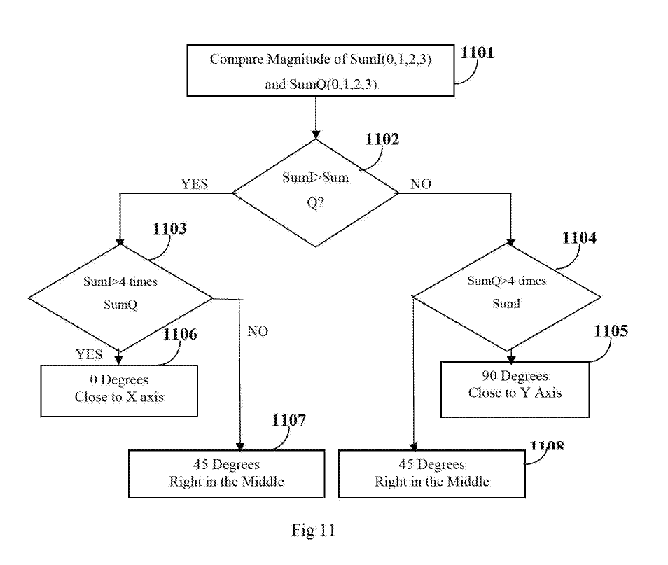

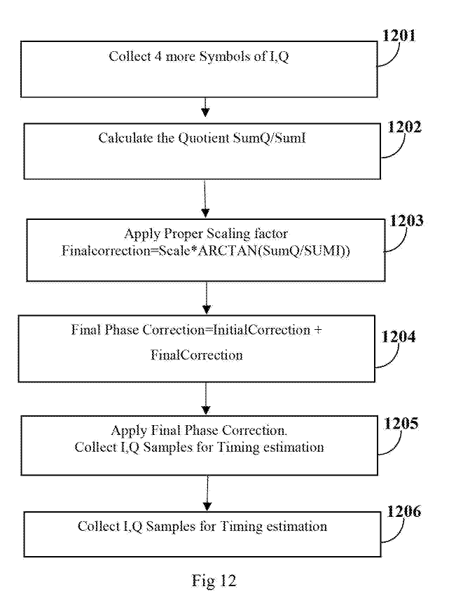

FIG. 10 and FIG. 11 describes the details of the two step phase estimation is described. FIG. 12 describes the equalizer and the timing estimation. This entire sequence allows the use of a lower sample rate of 12800 Hz and reduces the computational complexity.

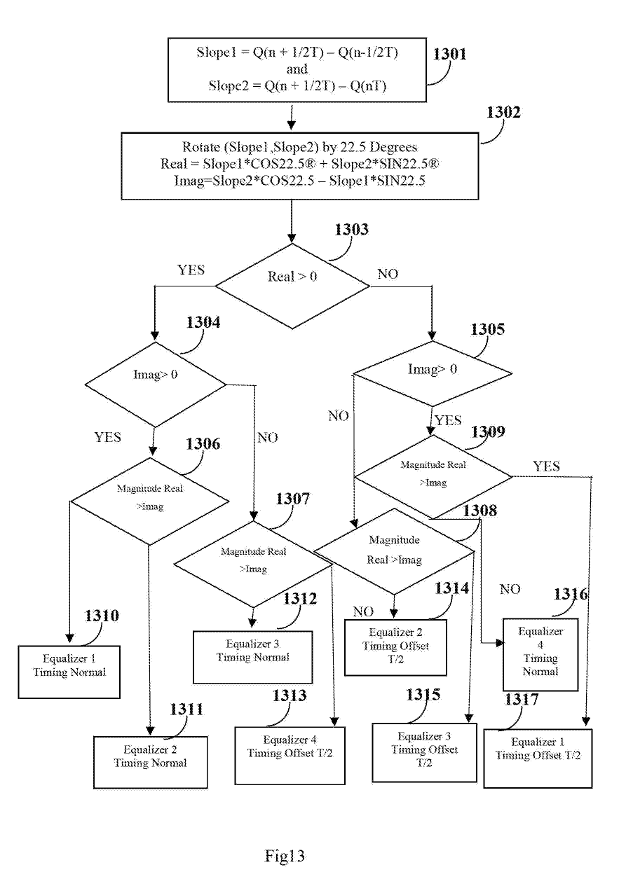

FIG. 13 describes the decision estimator in detail. The Phase Estimation process starts after sufficient energy has been detected by the Energy Detect circuit 803. After this, it collects the first 8 symbols of I and Q samples 807 from the output of Low Pass Filter 806. This is described as step 901 in FIG. 9. Then SumI and SumQ are calculated in 902. Four Quadrant decision making is done in 903 based on the sign of SumI and SumQ. The step 903 further narrows down the phase error estimate to within plus or minus 22.5 degrees by comparing magnitudes of SumI and SumQ. The step 905 applies this first estimate of phase correction. Then in step 906 four more I and Q samples are collected with the newly applied phase correction. Then, a final estimate of Phase Error is done in 907 by computing ARCTAN (SumQ/SumI). Approximation of Tan(θ)=θ, results in a simple math to get an estimate of the final phase correction needed. The step 908 applies this phase correction. Timing estimate starts with 909 collecting further 6 samples of I and Q. Using the formula outlined in 910 and a decision estimator in 911, the system arrives at an optimal timing estimate and a set of equalizer coefficients to allow the C8PSK receiver to be in the optimum detection range.

The Phase Error estimation happens in two phases. In the first phase, a coarse estimation is made within a 45 degree range and in the second phase it is further refined with a precise final estimate which is described in FIG. 10 and FIG. 11. In FIG. 10, at first 1001 calculates the Stint the sum of first 4 samples of I and SumQ the sum of first 4 samples of Q. 1002, 1003, 1004 checks the sign of SumI and SumQ to arrive at decision of which quadrant is the phase of the incoming signal belongs to in 1005,1006,1007,1008. FIG. 11 further refines the Phase Error estimate to be within 45 degree range by comparing the magnitudes of SumQ and SumI. Since the ARCTAN values and TAN(θ) values are effectively calculated which is a very large number near 90 degrees and a very small number near 0 respectively, it is reasonable to look at how big are SumQ is in relation to SumI and vice versa.

For example, if magnitude of SumQ is bigger than 4 times magnitude of SumI, it can be reasonably calculated that the estimated phase is closer to 90 degrees and if magnitude of SumI is bigger than 4 times magnitude of SumQ, it can be reasonably calculated that the estimated phase is closer to 0 degrees. When SumI and SumQ are comparable to each other the phase estimate is close to 45 degrees. The angles 0, 45, and 90 are example values for Quadrant I. The values for other Quadrants depends on which Quadrant it is in. 1102, 1003 and 1104 do these assessments and arrive at decisions 1105, 1106, 1007 and 1108.

The final estimate of Phase Error is done with four I and Q samples after the initial phase correction is applied. 1201 collects the four I and Q samples after the initial phase correction has been applied. To estimate the final Phase Error, the quotient of SumQ/SumI is calculated in 1202. A scaling factor normalizes the values of SumQ and SumI and an ARCTAN estimate is done in 1203. Approximation of tan(θ)=θ, results in a simple math to get an estimate of the final phase correction needed. 1204 adds the final Phase Correction to Initial Phase correction to arrive at the overall Phase Correction. 1205 and 1206 applies this final Phase Correction and start collecting I and Q samples for the next step which is equalizer timing estimation.

Timing estimation starts with calculating two rate of change values called Slope1 and Slope2 as shown in 1301 in FIG. 13. In order to make the math of decision estimate or easier, Slope 1 and Slope 2 are rotated by 22.5 degrees using a simple Cartesian rotation method as in 1302. Decision boxes 1303, 1304 and 1305 decide which of the four Quadrants the value belongs to. Decision boxes 1306, 1307, 1308 and 1309 further resolves it to the exact choice of Equalizer timing and the timing offset in 1310,1311,1312,1313,1314,1315,1316 and 1317. Once this choice is made, the equalizer is allowed to adapt to full convergence and the demodulation results in proper decoding of data.

The foregoing examples have been provided merely for the purpose of explanation and are in no way to be construed as limiting the otherwise broad scope of the present invention disclosed herein. While the present invention has been described with reference to various embodiments, it is understood that the words, which have been used herein, are words of description and illustration, rather than words of limitation. Further, although the present invention has been described herein with reference to particular means, materials, and embodiments, the invention is not intended to be limited to the particulars disclosed herein; rather, the invention extends to all functionally equivalent structures, methods and uses, such as are within the scope of the appended claims. Numerous modifications can be done to the present invention thereto and changes may be made without departing from the scope and spirit of the present invention in its aspects.

### REFERENCES

[1] Fisher Rosemount, “High Speed HART Prototype Modem Project” Prepared for The HART Communication Foundation. USA, 1999:35-60.
Wally Pratt. The HART PSK Physical Layer, A Status Report to HCF Members [R]. USA, 2000:6-7.
[3] Low-Power Digital Receiver Structure for Multi-Speed HART: Zhenghua Jin, Hong Wang, Zhijia Yang
International Journal of Digital Content Technology and its Applications. Volume 5, Number 4, April 2011
Jin Zhenghua, Wang Hong, Yang Zhijia. “Low Complexity Synchronization Algorithms for HART C8PSK,” IEEE 2010 internal colloquium on communication, control, and Management, Vol.1, August, 2010, pp: 608-611
Haran, Pranatharthi Subbaratnam. (2015) U.S. Pat. No. 9,203,665 B1. Washington, D.C.: U.S. Patent and Trademark Office.

We claim:

1. A method for modulating and transmitting an Analog signal comprising a highway addressable remote transducer message, said method comprising of:
a. Accepting as input said highway addressable remote transducer message and grouping them into 3 bits called symbols;
b. Further grouping sets of these symbols;
c. Implementing C8PSK modulation scheme in an efficient lookup table method to generate C8PSK signals which require only additions and subtractions and thus the requirements of computations are minimized significantly without need for any real time multiplication or other high power signal processing to generate said C8PSK signals;
where such a lookup table is generated ahead of time for a specific sample rate in a non-real time environment by making use of the properties of the C8PSK carrier frequency being in synchronization with the C8PSK baud rate and thus minimizing the size of this lookup table and the final C8PSK signals generated by a lookup table vector comprising of 3n bits representing the n symbols in time and m bits representing the number of C8PSK signals per symbol.

2. The method for modulating and transmitting C8PSK signals recited in claim 1, wherein the value of n and m in a Lookup table is 3 which results in a look table size of 4096 bytes.

3. The method for modulating and transmitting an C8PSK signals recited in claim 1, where the output sample rate is 12800 Hz or 25600 Hz.

4. A method for efficiently receiving and demodulating a C8PSK signal as recited in claim 1, wherein the estimation of the Phase Error of the incoming C8PSK signal is carried out in the steps of;
a. Sampling the incoming Analog C8PSK signal at a specified rate and generating I and Q signals twice per baud rate of 1/T seconds.
b. Estimating the incoming Phase Error to be within a specific Quadrant by inspecting sign values of certain measured I and Q values and further reducing the range to be within 45 degrees by magnitude comparison of certain measured values as;
c. Further applying the above measured first estimate of the correction for further collection of samples for the refinement of the phase Error Estimate to arrive at a final
d. Phase Error estimate and applying them cumulatively to aid in the subsequent step of Equalizer timing estimate.

5. The method for receiving and demodulating a C8PSK signal as recited in claim 4, wherein the phase error estimates are calculated for 0, 45, 90, 135, 180, 225, 270 and 315 degrees and the final Phase Error Estimate is calculated using the approximation tan(θ)=θ for small angles and approximating the quotient itself as an estimate of arc tan minimizing calculations required.

6. The method for receiving and demodulating a C8PSK signal as recited in claim 4, wherein the signal sampling rate is 12800 Hz and a T/2 equalizer is deployed, where T= 1/3200 Hz.

7. The method for receiving and demodulating a C8PSK signal as recited in claim 4, wherein the timing estimation is sequentially done with the Phase Error estimation and estimation of the precise timing and selection of the equalizer is done in a single step using a decision estimator based on some measured properties of the I and Q signals after the Phase Error correction has been applied.

8. The method for receiving and demodulating a C8PSK signal as recited in claim 4, wherein the equalizer selection is mapped to one of four equalizers.

9. The method for receiving and demodulating a C8PSK signal as recited in claim 4, wherein the choice of timing is mapped one of two timing choices i.e. 0 or T/2 where T= 1/3200 Hz.

10. The method for receiving and demodulating a C8PSK signal as recited in claim 4, wherein the automatic modulation classification is done by negating the presence of an FSK modulation by the positive assertion of the presence of C8PSK modulation or by the absence of C8PSK Signal and the presence of Energy detect to assert the presence of FSK signal.

11. The method for receiving and demodulating a C8PSK signal as recited in claim 4, wherein the timing sequences of methods finishes in time with the correct choice of the demodulation and the demodulator being in proper state to receive the message in either C8PSK or the FSK modes.
